(19) United States
(12) Patent Application Publication
(10) Pub. No.: US 2023/0154229 A1
(43) Pub. Date: May 18, 2023

(54) FINGERPRINT SENSING DEVICE AND DISPLAY DEVICE

(71) Applicant: HannsTouch Solution Incorporated, Tainan City (TW)

(72) Inventors: Sheng-Chia Lin, Tainan City (TW); Shi-Wei Ma, Tainan City (TW)

(73) Assignee: HannsTouch Solution Incorporated, Tainan City (TW)

(21) Appl. No.: 17/525,973

(22) Filed: Nov. 15, 2021

(51) Int. Cl. G06K 9/00; G06F 3/041

(52) U.S. Cl. CPC G06K 9/0002; G06F 3/0412; G06F 3/04164

(57) ABSTRACT

The present invention discloses a fingerprint sensing device and a display device, which include a substrate and a plurality of fingerprint sensing elements. The fingerprint sensing elements are disposed on the substrate and electrically insulated from each other. Each fingerprint sensing element includes a plurality of sensors. A width of one of the fingerprint sensing elements in a direction ranges from 5 mm to 20 mm.

### BACKGROUND OF THE INVENTION

### 1. Field of the Invention

The present invention relates a fingerprint sensing device and a display device, and more particularly to a fingerprint sensing device and a display device capable of detecting at least two fingerprint at the same time.

### 2. Description of the Prior Art

With development of advanced technology, fingerprint recognition has become a commonly used biometric recognition method, which uses a fingerprint sensing device to detect a user's fingerprint to identify the user's identity. However, most conventional fingerprint sensing devices can only detect a single fingerprint at a time and cannot recognize multiple fingerprints at a time; or although they may have multiple fingerprint recognition functions, misjudgment or unstable recognition still easily occur in these devices.

### SUMMARY OF THE INVENTION

An embodiment of the present invention provides a fingerprint sensing device. The fingerprint sensing device includes a substrate and a plurality of fingerprint sensing elements. The fingerprint sensing elements are disposed on the substrate and electrically insulated from each other. Each of the fingerprint sensing elements includes a plurality of sensors, and a width of one of the fingerprint sensing elements in a direction ranges from 5 mm to 20 mm.

Another embodiment of the present invention provides a display device having a display region and including a fingerprint sensing device. The fingerprint sensing device includes a substrate and a plurality of fingerprint sensing elements disposed on the substrate in the display region and electrically insulated from each other. Each of the fingerprint sensing elements includes a plurality of sensors, and a width of one of the fingerprint sensing elements in a direction ranges from 5 mm to 20 mm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a fingerprint sensing device performing multiple fingerprint detection according to a first embodiment of the present invention.

FIG. 2 schematically illustrates a top view of a fingerprint sensing device according to a second embodiment of the present invention.

FIG. 3 schematically illustrates a top view of the fingerprint sensing device performing multiple fingerprint detection according to the second embodiment of the present invention.

FIG. 4 schematically illustrates a top view of the fingerprint sensing device performing detection to the fingerprints with larger position changes according to the second embodiment of the present invention.

FIG. 5 schematically illustrates a top view of the fingerprint sensing element according to the second embodiment of the present invention.

FIG. 6 schematically illustrates a top view of a fingerprint sensing element according to a variant embodiment of the second embodiment of the present invention.

FIG. 7 schematically illustrates a top view of a fingerprint sensing device according to a third embodiment of the present invention.

FIG. 8 schematically illustrates a top view of a fingerprint sensing device according to a fourth embodiment of the present invention.

FIG. 9 schematically illustrates a cross-sectional view of a display device according to an embodiment of the present invention.

FIG. 10 schematically illustrates a top view of a display device according to another embodiment of the present invention.

### DETAILED DESCRIPTION

The contents of the present invention will be described in detail with reference to specific embodiments and drawings. It is noted that, for purposes of illustrative clarity and being easily understood by the readers, the following drawings may be simplified schematic diagrams, and elements therein may not be drawn to scale. The numbers and dimensions of the elements in the drawings are just illustrative and are not intended to limit the scope of the present invention.

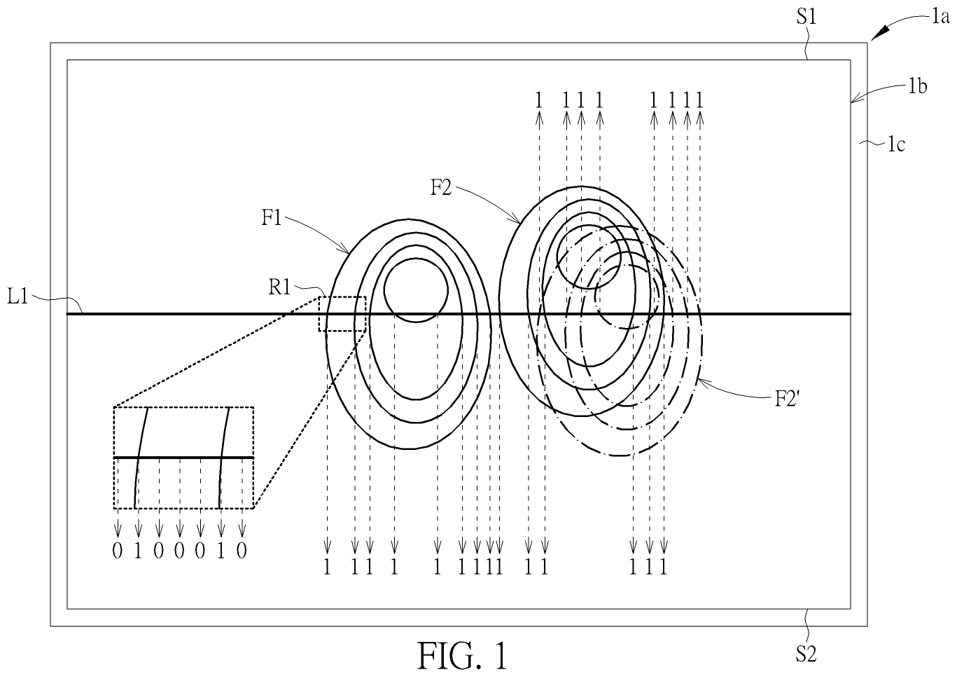

Refer to FIG. 1, which schematically illustrates a fingerprint sensing device performing detection to multiple fingerprints according to a first embodiment of the present invention. As shown in FIG. 1, in the fingerprint sensing device 1a of this embodiment, a fingerprint sensing element 1b may be disposed on a substrate 1c. When the fingerprint sensing device 1a detects multiple fingerprints, multiple fingers F1 and F2 are disposed on the same fingerprint sensing element 1b of the fingerprint sensing device 1a, and the fingerprint sensing element 1b detects the fingerprints of the fingers F1 and F2 by scanning row by row, that is, the fingerprint sensing element 1b may detect the fingerprints sequentially along multiple line segments L1, such that a signal code combination corresponding to an entire fingerprint of the finger F1 and the finger F2 may be obtained after the fingerprint sensing element 1b scans from a first side S1 to a second side S2 along a column direction of sensors. In FIG. 1, the line segment L1 is as an example for representing a signal code arrangement detected from the fingerprints of the fingers F1 and F2 in the same row, but not limited thereto. When the fingerprint sensing element 1b detects the fingerprints of the fingers F1 and F2 along the line segment L1 (i.e., by using sensors in the same row), the signal code arrangement of ridge signals and valley signals detected from the fingerprints of the finger F1 and the finger F2 on the line segment L1 may be obtained at the same time, in which the ridge signal is represented by “1”, and the valley signal is represented by “0”. Through the relative positions and the signal codes of ridges and valleys, the signal code arrangement of the fingerprints of the finger F1 and the finger F2 on the line segment L1 may be obtained. Since the signal codes on the same line segment L1 are separated by the same interval, the local signal code arrangement may be 01000100, for example, as shown in an enlarged view of a region R1 in FIG. 1.

However, in the fingerprint sensing device 1a of FIG. 1, the user cannot ensure that a relative position between the finger F1 and the finger F2, a pressing pattern of the finger F1 and/or a pressing pattern of the finger F2 maintain the same every time the user presses, such that the relative position between the finger F1 and the finger F2, the pressing pattern of the finger F1 and/or the pressing pattern of the finger F2 are easily changed. As shown in FIG. 1, as the relative position between the finger F1 and the finger F2 changes, for example, the finger F2 moves to the position of the finger F2′ at the next time touching, a distance between the fingerprint of the finger F2′ and the fingerprint of the finger F1 will change, so that the signal code combination of the ridge signals and the valley signals detected by the fingerprint sensing element 1a will change. Accordingly, the signal coding combination detected this time is different from the signal coding combination detected last time. When the signal code combination alters, the control element of the fingerprint sensing device 1a cannot accurately recognize whether the signal code combination is detected from fingerprints of different fingers of the same person. In other words, the fingerprints of different fingers F1 and F2 may interfere with each other during detection, resulting in misjudgment, which makes the fingerprint sensing device 1a of FIG. 1 difficult to accurately detect multiple fingerprints at a time. Therefore, the fingerprint sensing device 1a needs extra algorithm to further distinguish the fingerprint of the finger F1 from the fingerprint of the finger F2, but this method will increase load of control element, reduce detection accuracy, and decrease recognition efficiency.

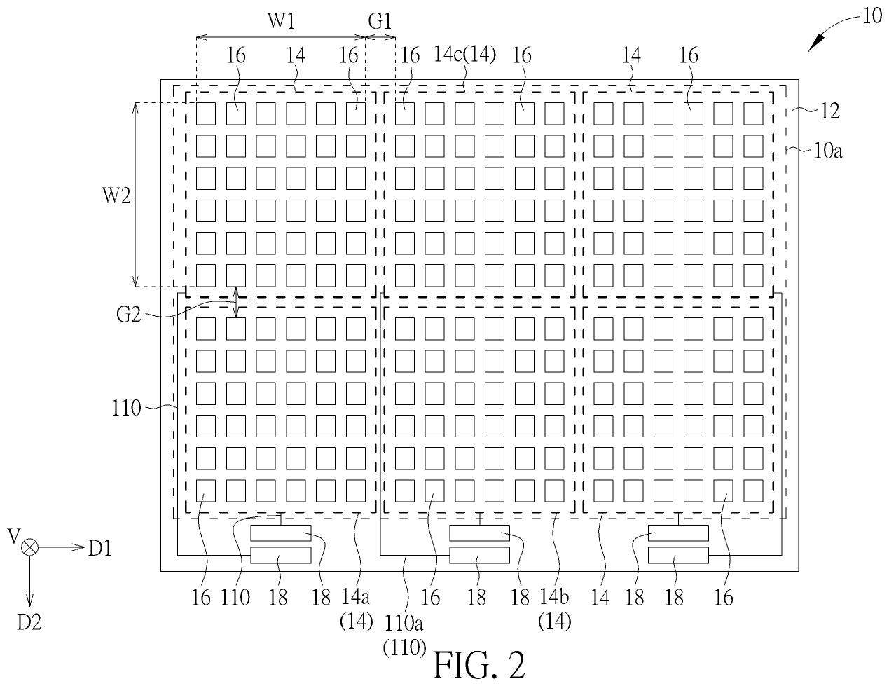

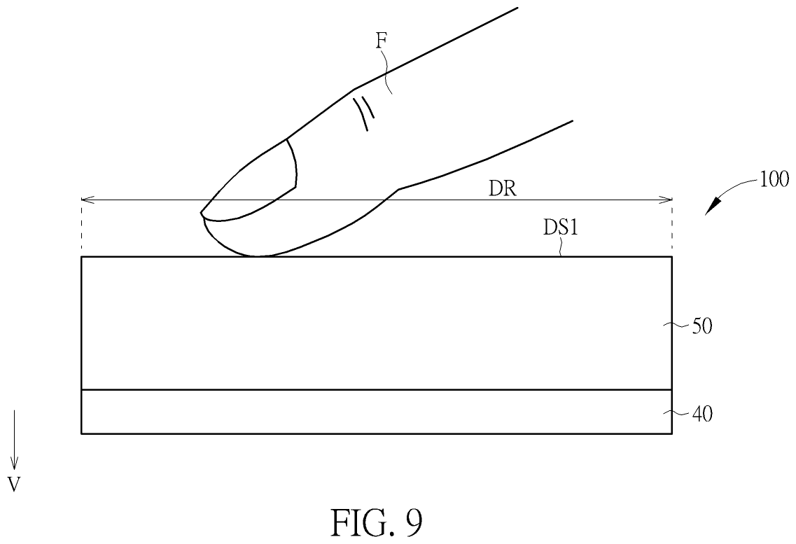

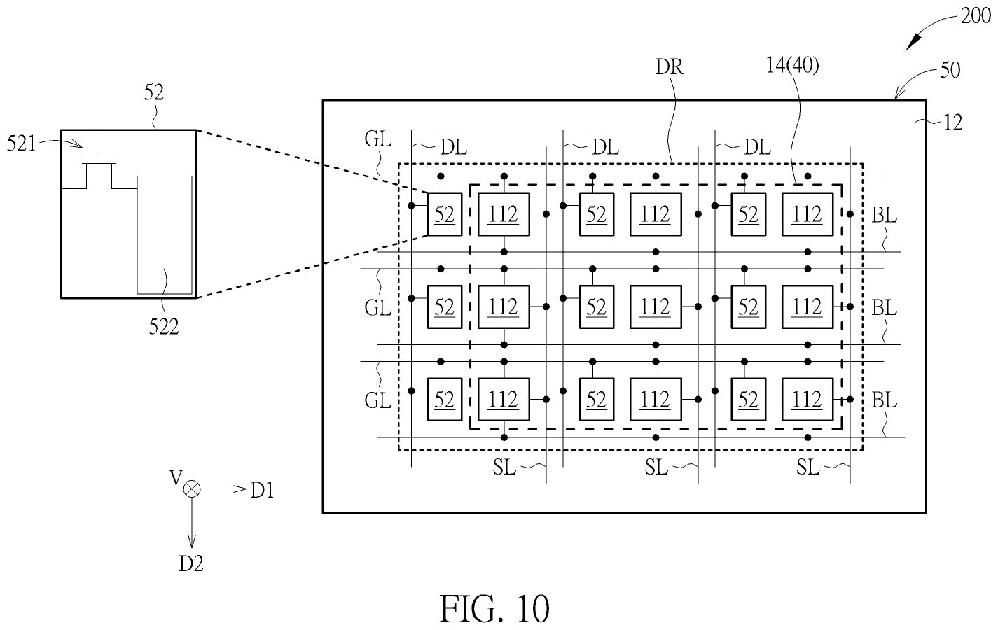

FIG. 2 schematically illustrates a top view of a fingerprint sensing device according to a second embodiment of the present invention. As shown in FIG. 2, the fingerprint sensing device 10 may include a substrate 12 and a plurality of fingerprint sensing elements 14 disposed on the substrate 12. The substrate 12 may include, for example, a flexible or rigid transparent substrate, such as glass, quartz, sapphire, plastic, or other suitable substrates. The fingerprint sensing elements 14 are controlled independently of each other to detect the fingerprints of the fingers respectively, so that the fingerprint detections of adjacent fingerprint sensing elements 14 do not interfere with each other. For example, the fingerprint sensing elements 14 may be electrically insulated from each other. Specifically, the fingerprint sensing device 10 may have a fingerprint sensing region 10a, and the fingerprint sensing elements 14 are disposed in the fingerprint sensing region 10a. Moreover, in the fingerprint sensing region 10a, any two adjacent fingerprint sensing elements 14 are not electrically connected to each other (i.e., electrically insulated from each other). In other words, in the fingerprint sensing region 10a, any two adjacent fingerprint sensing elements 14 may not be directly electrically connected to each other through conductive lines. In some embodiments, as the fingerprint sensing device 10 is applied to a display device 100, the fingerprint sensing region 10a may be the same as or like a display region (e.g., the display region DR shown in FIG. 9 or FIG. 10) of the display device 100.

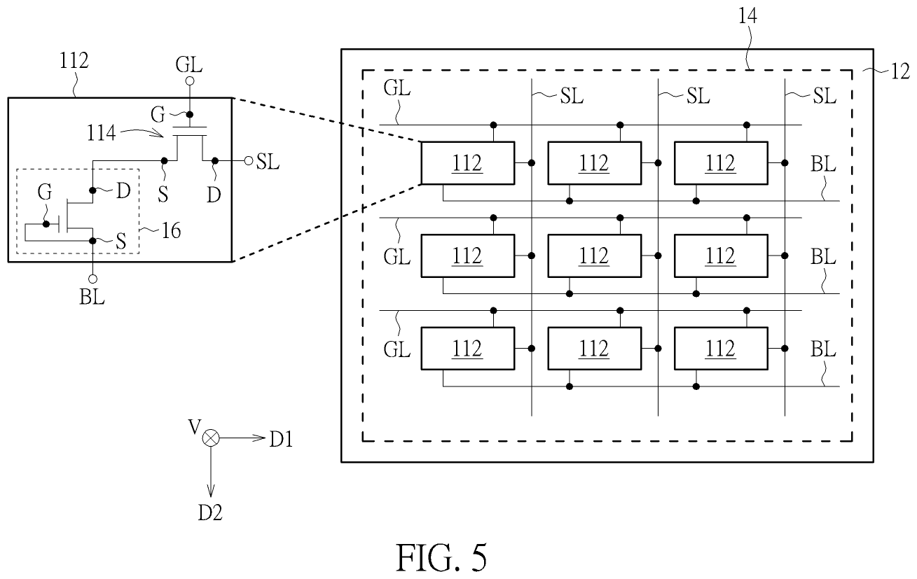

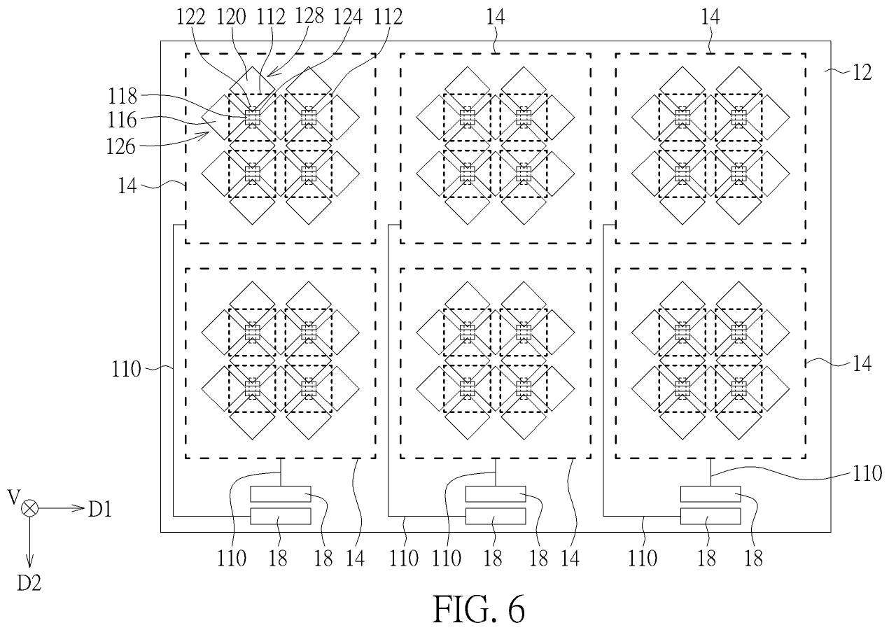

As shown in FIG. 2, each fingerprint sensing element 14 may include a plurality of sensors 16 for detecting patterns of different parts of the fingerprint. The sensors 16 of different fingerprint sensing elements 14 may be electrically insulated from each other. The sensor 16 may include, for example, a light sensor or other kinds of sensors. The light sensor may include, for example, a photosensitive transistor (the sensor 16 as shown in FIG. 5), a photodiode, or other suitable photoelectric conversion elements, where the photosensitive transistor may be, for example, a thin film transistor or other types of transistors. In the embodiment of FIG. 2, the sensors 16 of one of the fingerprint sensing elements 14 may be arranged in an array or other suitable arrangements to detect fingerprint images. The number and distribution density of the sensors 16 in one of the fingerprint sensing elements 14 are not limited to those shown in FIG. 2 and may be determined according to requirements or resolution that fingerprint images may be recognized. In some embodiments, the fingerprint sensing element 14 may be, for example, a capacitive fingerprint sensing element. In this case, a sensing unit of the fingerprint sensing element 14 (e.g., the sensing unit 112 shown in FIG. 6) may be used as the sensor 16 of FIG. 2.

As shown in FIG. 2, it should be noted that a width W1 of the fingerprint sensing element 14 in a first direction D1 may be, for example, substantially the same as a width of one finger of the user. In some embodiments, a width W2 of the fingerprint sensing element 14 in a second direction D2 may also be, for example, substantially the same as the width of one finger of the user. In an embodiment, the width W1 and/or the width W2 of the fingerprint sensing element 14 may be, for example, a distance between the outer sides of two outermost sensors 16 of the fingerprint sensing element 14 arranged in the first direction D1 or the second direction D2, but not limited thereto. For example, the width W1 and/or the width W2 may, for example, range from 5 mm to 20 mm, but not limited thereto. In addition, a distance G1 between two adjacent fingerprint sensing elements 14 arranged in the first direction D1 and/or a distance G2 between two adjacent fingerprint sensing elements 14 arranged in the second direction D2 may be, for example, greater than 2 mm and/or less than or equal to 5 mm, so that it is not easy for two fingers to press on the same fingerprint sensing element 14 at the same time. In an embodiment, each of the distance G1 and the distance G2 may refer to a distance between two closest sensors 16 of two adjacent fingerprint sensing elements 14, but not limited thereto.

As shown in FIG. 2, the fingerprint sensing device 10 may further include a plurality of control elements 18 and a plurality of connecting line groups 110, which are disposed on the substrate 12, and at least two fingerprint sensing elements 14 may be electrically connected to at least two control elements 18, respectively. The control element 18 may include, for example, a driver chip or other suitable chip for independently driving or controlling the corresponding fingerprint sensing element 14 to perform fingerprint detection; i.e., the fingerprint sensing elements 14 may be independently driven to detect rather than being controlled by connecting them to each other in series. In the embodiment of FIG. 2, each control element 18 may be electrically connected to the corresponding fingerprint sensing element 14 in a one-to-one manner through the corresponding connecting line group 110, but not limited thereto. FIG. 2 only shows the control element 18 is electrically connected to the corresponding fingerprint sensing element 14 by a single connecting line group 110 as an example, but not limited thereto. In some embodiments, one of the fingerprint sensing elements 14 may be electrically connected to the corresponding control element 18 through a plurality of connecting line groups 110. Although not shown in FIG. 2, each connecting line group 110 may be composed of a plurality of lines for electrically connecting the sensors 16 of the corresponding fingerprint sensing element 14 to the corresponding control element 18, respectively. In addition, in the fingerprint sensing region 10a of the fingerprint sensing device 10, adjacent connecting line groups 110 may not be electrically connected to each other. In some embodiments, the number of lines of one of the connecting line groups 110 may be less than the number of sensors 16 of the corresponding fingerprint sensing element 14 electrically connected to this connecting line group 110, but not limited thereto. In some embodiments, the number of the control elements 18 may be different from the number of the fingerprint sensing elements 14. For example, the number of the fingerprint sensing elements 14 may be greater than the number of the control elements 18; for example, multiple fingerprint sensing elements 14 may be electrically connected to and controlled by the same control element 18. In the embodiment of FIG. 2, a part of the connecting line groups 110 may be disposed between adjacent fingerprint sensing elements 14, but not limited thereto. In some embodiments, at least one connecting line group 110 may be disposed between adjacent fingerprint sensing elements 14. For example, the connecting line group 110a, the fingerprint sensing element 14a, the fingerprint sensing element 14b, and the fingerprint sensing element 14c may be disposed in the display region (the display region DR shown in FIG. 9 or FIG. 10), and the connecting line group 110a may be disposed between the fingerprint sensing element 14a and the fingerprint sensing element 14b. In this case, the connecting line group 110a may be electrically connected to the fingerprint sensing element 14c and electrically insulated from the fingerprint sensing element 14a and the fingerprint sensing element 14b. In some embodiments, when the fingerprint sensing device 10 is applied to a display panel (such as the display panel 50 shown in FIG. 9 or FIG. 10), the control element 18 may be disposed in the non-display region of the display panel, and the sensors 16 may be disposed in the display region (the display region DR shown in FIG. 9 or FIG. 10) of the display panel.

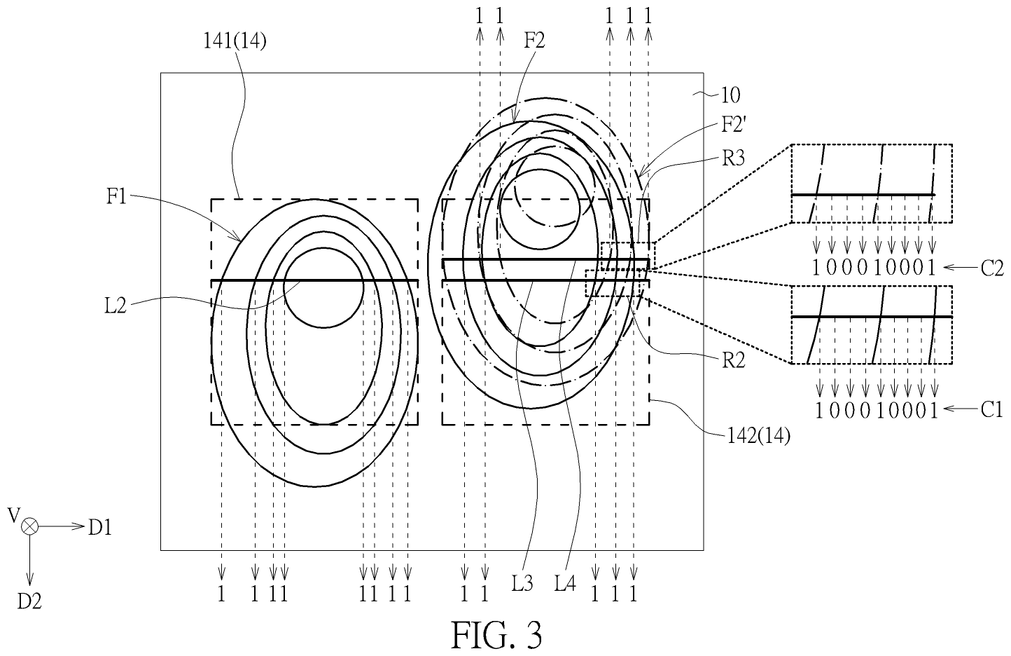

FIG. 3 schematically illustrates a top view of the fingerprint sensing device performing multiple fingerprint detection according to the second embodiment of the present invention. In FIG. 3, the fingerprint sensing device 10 performs detection to the fingerprints of two fingers F1 and F2 as an example, but not limited thereto. Since the width W1 of the fingerprint sensing element 14 in the first direction D1 and/or the width W2 of the fingerprint sensing element 14 in the second direction D2 may be substantially the width of a user's finger, when the finger F1 and the finger F2 are put on the fingerprint sensing device 10, the finger F1 and the finger F2 may be respectively located on different fingerprint sensing elements 141, 142, such that fingerprint patterns of the finger F1 and the finger F2 may be detected by the different fingerprint sensing elements 141, 142 respectively. In such case, interference resulted from the different relative positions between the finger F1 and the finger F2 when they touch the fingerprint sensing device 10 multiple times and are detected by the same fingerprint sensing element 14 may be avoided. For example, when the finger F1 and the finger F2 are put on the fingerprint sensing device 10 for the first time, the fingerprint sensing element 141 corresponding to the finger F1 may detect a signal code combination corresponding to the finger F1. For example, the sensors of the same row corresponding to the line segment L2 (e.g., the sensors 16 in the same row as shown in FIG. 2) may detect the ridge signals and the valley signals of the corresponding finger F1 to obtain a signal code arrangement, and then, by scanning the sensors of different rows, an entire signal code combination corresponding to the fingerprint pattern of the finger F1 may be obtained. The fingerprint sensing element 142 corresponding to the finger F2 may detect another signal code combination corresponding to the finger F2. For example, the sensors of the same row corresponding to a line segment L3 may detect the ridge signals and the valley signals of the corresponding finger F2 to obtain another signal code arrangement, such as the signal code arrangement C1 shown in an enlarged view of the region R2 in FIG. 3, where the ridge signal may be represented by “1” and the valley signal may be represented by “0”. The entire signal code combination corresponding to the fingerprint pattern of the finger F2 may be obtained by scanning sensors of different rows of the fingerprint sensing element 142. When the fingers F1 and F2 are put on the fingerprint sensing device 10 again, a position of the finger F1 may not change, and the finger F2 may move to the position of the finger F2′, for example. In this case, the fingerprint sensing element 141 may still detect a fingerprint pattern corresponding to the same signal code combination. For example, the sensors corresponding to the line segment L2 may detect the same signal code arrangement of the ridge signals and the valley signals. Since the position of the finger F2′ is different from the position of the finger F2, the sensors of the same row corresponding to the line segment L3 of the fingerprint sensing element 142 may not detect the same signal code arrangement, but the fingerprint sensing element 142 may still detect a signal code combination this time, at least a part of which is the same as at least apart of the signal code combination corresponding to the finger F2 detected last time. For example, since the fingerprint sensing element 142 and the fingerprint sensing element 141 are controlled independently of each other, the fingerprint sensing element 142 may detect the signal code arrangement (such as the signal code arrangement C2 shown in an enlarged view of the region R3 in FIG. 3) of the ridge signals and the valley signals of the finger F2′ through the sensors of the same row corresponding to the line segment L4. Since the signal code arrangement C2 is the same as the signal code arrangement C1, the fingerprint sensing device 10 may recognize that the finger F2′ may be the same as the finger F2 through the signal code arrangement C1 and the signal code arrangement C2, for example. In other words, the fingerprint sensing device 10 may detect multiple fingerprints at the same time without being affected by changes in the relative positions between the finger F1 and the finger F2, thereby achieving multi-fingerprint recognition at the same time. In addition, since a distance between two adjacent fingerprint sensing elements 14 may be greater than 2 mm, it is possible to reduce or prevent two fingers F1 and F2 or two fingers F1 and F2′ from pressing on the same fingerprint sensing element 14 at the same time. Accordingly, misjudgment may be avoided, the detection accuracy may be improved, and the recognition efficiency may be reduced. In some embodiments, since the fingerprint patterns of the finger F1 and the finger F2′ may be detected by different fingerprint sensing elements 141 and 142, respectively, even if the pressing pattern of at least one of the finger F1 and the finger F2′ changes, the control element 18 in the fingerprint sensing device 10 may still separately recognize whether the pressing pattern of the finger F1 and the pressing pattern of the finger F2′ are correct, thereby improving the detection accuracy.

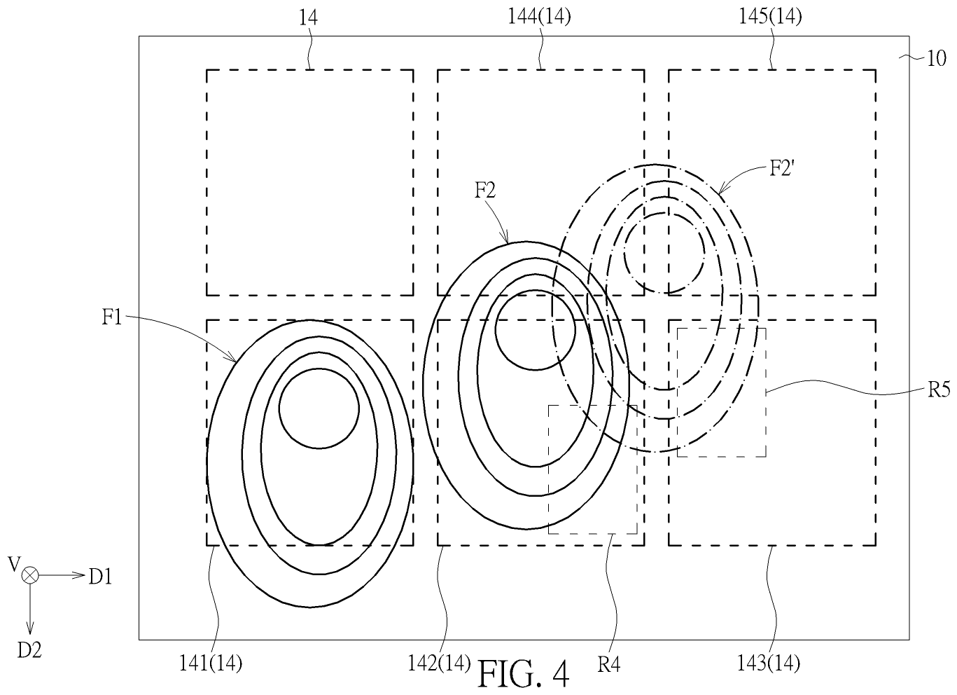

FIG. 4 schematically illustrates a top view of the fingerprint sensing device performing detection to the fingerprints with larger changes in relative position according to the second embodiment of the present invention. As shown in FIG. 4, the fingerprint sensing element 142 may detect the signal code combination of the finger F2. Although the position of the finger F2′ is farther from the position of original finger F2, the signal code combination detected by another fingerprint sensing element 143 from the region R5 may still be the same as a part of the signal code combination corresponding to the region R4 detected by the fingerprint sensing element 142. Alternatively, other fingerprint sensing elements (such as the fingerprint sensing element 142, the fingerprint sensing element 144, and/or the fingerprint sensing element 145) may respectively detect the signal code combinations corresponding to fingerprint patterns of the other parts of the finger F2′, and by integrating the detected signal code combinations, it may be recognized whether the finger F2′ is the same as the finger F2. Therefore, no matter how much the relative positions between multiple fingers change, the finger F1 and the finger F2 or the finger F1 and the finger F2′ may be prevented from pressing on the same fingerprint sensing element 14 by multiple fingerprint sensing elements 14 controlled independently of each other, thereby improving the detection accuracy. In some embodiments, a pattern size corresponding to the signal code combination detected from the region R5 of the fingerprint sensing element 143 may be, for example, substantially greater than or equal to 25% of the fingerprint pattern of a single finger, so that the signal code combination detected from the region R5 may have enough fingerprint data for recognition.

FIG. 5 schematically illustrates a top view of the fingerprint sensing element according to the second embodiment of the present invention. As shown in FIG. 5, the fingerprint sensing element 14 of this embodiment may include a plurality of sensing units 112, and each sensing unit 112 may include one sensor 16 and a switch transistor 114, but not limited thereto. The sensing unit 112 may be arranged in an array or other suitable arrangement to detect fingerprint images. In the embodiment of FIG. 5, the sensor 16 is a photosensitive transistor as an example, but not limited thereto. A gate G of the sensor 16 may be electrically connected to a source S of the sensor 16, and a drain D of the sensor 16 may be electrically connected to a source S of the switch transistor 114. The switch transistor 114 may be, for example, a bottom-gate type, a top-gate type, or other types of transistors, and the sensor 16 may be, for example, a bottom-gate type, a top-gate type, a deviated-gate type, or other types of transistors. The sensor 16 in FIG. 5 is the deviated-gate type transistor as an example, but not limited thereto. The semiconductor layers of photosensitive transistor of the sensor 16 and the switch transistor 114 may include, for example, amorphous silicon, polysilicon, oxide semiconductor, or other suitable semiconductor materials. The sensor 16 of the present invention is not limited to the photosensitive transistor. In some embodiments, the photosensitive transistor may be replaced with a photodiode or other suitable photoelectric conversion elements.

As shown in FIG. 5, in addition to the sensing unit 112, the fingerprint sensing element 14 may further include, for example, a plurality of scan lines GL, a plurality of sensing lines SL, and a plurality of bias lines BL, which are disposed on the substrate 12, but not limited thereto. In each sensing unit 112, the source S of the photosensitive transistor may be electrically connected to the corresponding bias line BL, and a gate G and a drain D of the switch transistor 114 may be electrically connected to the corresponding scan line GL and the corresponding sensing line SL, respectively, but not limited thereto. The scan lines GL, the sensing lines SL and the bias lines BL may be electrically connected to the corresponding control element 18 through different lines, for example. It should be noted that circuit configuration of the fingerprint sensing element 14 of the present invention is not limited to that shown in FIG. 5 and may further include other suitable elements. The sensor 16 is not limited to that shown in FIG. 5 and may be adjusted according to requirements.

FIG. 6 schematically illustrates a top view of a fingerprint sensing element according to a variant embodiment of the second embodiment of the present invention. As shown in FIG. 6, each fingerprint sensing element 14 of this variant embodiment may be a capacitive fingerprint sensing element and may include a plurality of sensing units 112. Different fingerprint sensing elements 14 are still electrically insulated from each other and are respectively electrically connected to the corresponding control elements 18 through the connecting line groups 110.

In the variant embodiment of FIG. 6, each fingerprint sensing element 14 may include a plurality of first sensing pads 116, a plurality of first bridge structures 118, a plurality of second sensing pads 120, a plurality of second bridge structures 122, and a plurality of insulating blocks 124. The first sensing pads 116 and the first bridge structures 118 arranged in the first direction D1 may be connected to form a plurality of first sensing strings 126 extending along the first direction D1, and the second sensing pads 120 and the second bridging structure 122 arranged in the second direction D2 may be connected to form a plurality of second sensing strings 128 extending along the second direction D2. The first bridge structure 118 may cross the corresponding second bridge structure 122 in the top view direction V, such that the first sensing strings 126 may cross the second sensing strings 128 in the top view direction V. The insulating blocks 124 may be disposed between the first bridge structure 118 and the corresponding second bridge structure 122 to electrically insulate the first sensing strings 126 and the second sensing strings 128. In some embodiments, the insulating blocks 124 may be connected to each other to form a single insulating layer, and the second bridge structure 122 may be electrically connected to the corresponding second sensing pads 120 through openings of the insulating layer, but not limited thereto. Those skilled in the art should understand that layers for forming the first sensing pads 116, the first bridge structures 118, the second sensing pads 120, and the second bridge structures 122 may be adjusted based on requirements and will not be detailed. In this variant embodiment, one of the sensing units 112 may be formed at an intersection of one of the first sensing strings 126 and one of the second sensing strings 128. For example, portions of two adjacent first sensing pads 116, one of the first bridge structures 118 disposed between the two adjacent first sensing pads 116, portions of two adjacent second sensing pads 120, and one of the second bridge structures 122 disposed between the two adjacent second sensing pads 120 may form one of the sensing units 112, but not limited thereto. It should be noted that the sensing unit 112 of this variant embodiment may not need additional switch transistors 114 and may be directly used as the sensor 16 shown in FIG. 2. The number of the first sensing pads 116, the first bridge structures 118, the second sensing pads 120, and the second bridge structures 122 in a single fingerprint sensing element 14 is not limited to that shown in FIG. 6 and may be changed according to requirements or resolution for recognition. In some embodiments, the first sensing strings 126 and the second sensing strings 128 may be stripe-shaped, but not limited thereto.

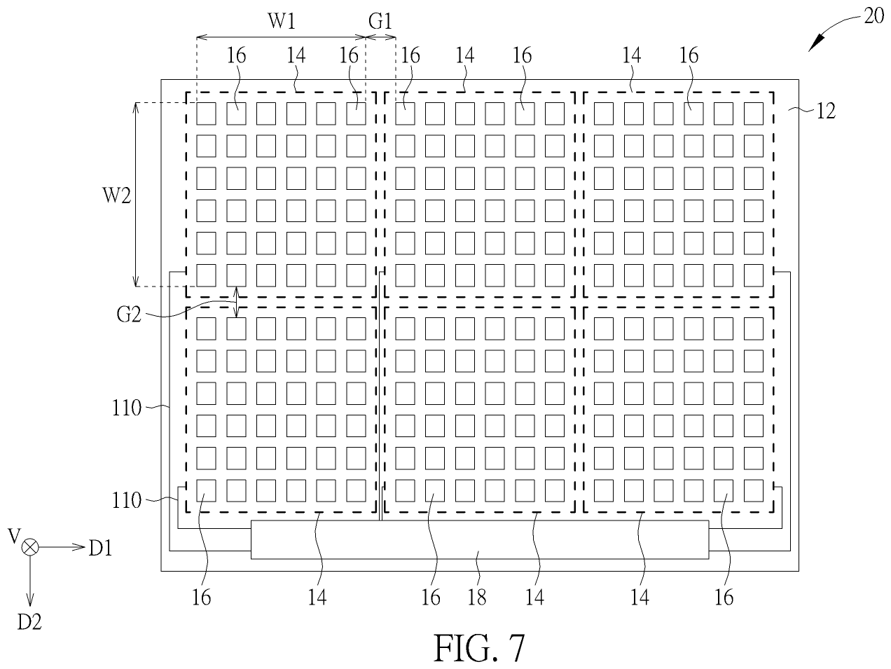

FIG. 7 schematically illustrates a top view of a fingerprint sensing device according to a third embodiment of the present invention. As shown in FIG. 7, the fingerprint sensing device 20 of this embodiment differs from the fingerprint sensing device 10 of FIG. 2 in that the fingerprint sensing elements 14 of this embodiment are electrically connected to the same control element 18 respectively, and the control element 18 independently control the fingerprint sensing elements 14, such that the fingerprint sensing elements 14 do not affect each other. The fingerprint sensing element 14 of this embodiment may use the fingerprint sensing element of any of the above-mentioned embodiments or their variant embodiment.

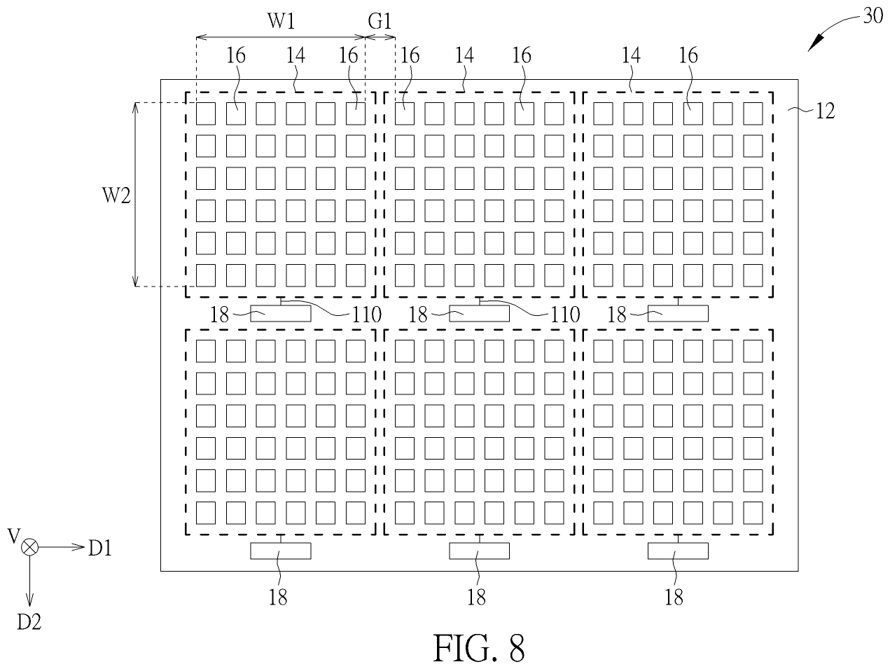

FIG. 8 schematically illustrates a top view of a fingerprint sensing device according to a fourth embodiment of the present invention. As shown in FIG. 8, the fingerprint sensing device 30 of this embodiment differs from the fingerprint sensing device 10 of FIG. 2 in that at least a part of the control elements 18 of this embodiment may be disposed between adjacent fingerprint sensing elements 14. For example, when the fingerprint sensing device 30 is disposed on the display panel, the control elements 18 may be disposed corresponding to the black matrix in the display region of the display panel, but not limited thereto. The fingerprint sensing element 14 of this embodiment may use the fingerprint sensing element of any of the above-mentioned embodiments or their variant embodiment.

FIG. 9 schematically illustrates a cross-sectional view of a display device according to an embodiment of the present invention. As shown in FIG. 9, the fingerprint sensing device 40 may be applied to the display device 100. Specifically, the display device 100 may have a display region DR, and a plurality of fingerprint sensing elements of the fingerprint sensing device 40 may be disposed in the display region DR to detect fingerprint of the finger F. The fingerprint sensing device 40 of this embodiment may adopt the fingerprint sensing device of any of the above-mentioned embodiments and will not be redundantly described. The display device 100 may further include a display panel 50, and the fingerprint sensing device 40 may be disposed under the display panel 50. In some embodiments, the fingerprint sensing device 40 may be disposed on a display surface DS1 of the display panel 50, but not limited thereto. The display panel 50 of FIG. 9 is an organic light-emitting diode (organic light-emitting diode) display panel as an example, but not limited thereto. In some embodiments, the display panel 50 may include, for example, a micro light-emitting diode (micro light-emitting diode) display panel, a liquid crystal display panel, or other suitable display panels. In some embodiments, the control element (such as the control element 18 shown in FIG. 2, FIG. 6, or FIG. 7) of the fingerprint sensing device 40 may be disposed in a peripheral region outside the display region DR of the display device 100. Alternatively, when the control element 18 (such as the control element 18 shown in FIG. 8) is disposed between adjacent fingerprint sensing elements 14, the control element 18 may be disposed in the display region DR of the display device 100.

FIG. 10 schematically illustrates a top view of a display device according to another embodiment of the present invention. As shown in FIG. 10, the display device 200 of this embodiment differs from the display device 100 of FIG. 9 in that the fingerprint sensing device 40 of this embodiment may be embedded and disposed in the display panel 50. The fingerprint sensing device 40 of FIG. 10 only displays one fingerprint sensing element 14, but the fingerprint sensing device 40 may still include a plurality of fingerprint sensing elements 14, as shown in FIG. 2, FIG. 6, FIG. 7, or FIG. 8. The fingerprint sensing device 40 of this embodiment may adopt the fingerprint sensing device of any of the above-mentioned embodiments and will not be redundantly described. As shown in FIG. 10, the display panel 50 may include a plurality of display pixel units 52, a plurality of data lines DL, a plurality of scan lines GL, a plurality of sensing lines SL, and a plurality of bias lines BL, which are disposed on the substrate 12. The fingerprint sensing elements 14 may be disposed on the same substrate 12. In the embodiment of FIG. 10, each display pixel unit 52 may respectively correspond to one sensing unit 112, but not limited thereto. In some embodiments, multiple display pixel units 52 may correspond to one sensing unit 112, or one display pixel unit 52 may correspond to multiple sensing units 112. Each display pixel unit 52 may include a switch transistor 521 and a pixel electrode 522, and a gate, a source, and a drain of the switch transistor 521 may be electrically connected to the corresponding scan line GL, data line DL, and pixel electrode 522, respectively. In one embodiment, if the display panel 50 is a liquid crystal display, the pixel electrode 522 may be used to drive liquid crystal. As shown in FIG. 10, by the data signals of the data lines DL and the scan signals of the scan lines GL, the light intensity of the display pixel units 52 may be controlled to display images. Since structure of the sensing units 112 and electrical connections of the sensing units 112 with the corresponding scan lines GL, the sensing lines SL, and the bias lines BL may be, for example, the same as the structure and electrical connection shown in FIG. 5 and will not be repeated herein. In some embodiments, light generated by the display pixel units 52 may be used as a light source for detecting fingerprints, but not limited thereto. In addition, in other embodiments, the display panel 50 may be an organic light emitting diode display panel.

In summary, in the fingerprint sensing device of the present invention, since a plurality of fingerprint sensing elements controlled independently with sizes close to the size of the finger are provided, when multiple fingers touch the fingerprint sensing device, the issue that two fingers are disposed on the same fingerprint sensing element at the same time may be mitigated, such that multiple fingerprints may be detected at the same time by different fingerprint sensing elements. Therefore, the detection of multiple fingerprints at the same time will not be affected by the changes in relative positions between the fingers, thereby avoiding misjudgment.

Those skilled in the art will readily observe that numerous modifications and alterations of the device and method may be made while retaining the teachings of the invention. Accordingly, the above disclosure should be construed as limited only by the metes and bounds of the appended claims.

1. A fingerprint sensing device, comprising:
a substrate;
a plurality of fingerprint sensing elements disposed on the substrate and electrically insulated from each other, wherein each of the plurality of fingerprint sensing elements comprises a plurality of sensors, a plurality of scan lines extending along a direction, a plurality of sensing lines and a plurality of bias lines, a width of one of the plurality of fingerprint sensing elements in the direction ranges from 5 mm to 20 mm, and at least two of the plurality of fingerprint sensing elements arranged along the direction are electrically insulated from each other; and
at least one control element disposed on the substrate, wherein the plurality of fingerprint sensing elements are controlled independently of each other by the at least one control element, wherein the at least one control element comprises a driver chip, and the fingerprint sensing device is capable of detecting at least two fingerprints at a same time.

2. The fingerprint sensing device as claimed in claim 1, wherein the at least one control element comprises at least two control elements, and the at least two of the plurality of fingerprint sensing elements are electrically connected to the at least two control elements respectively.

3. The fingerprint sensing device as claimed in claim 1, wherein the at least two of the plurality of fingerprint sensing elements are electrically connected to the at least one control element.

4. The fingerprint sensing device as claimed in claim 1, wherein a distance between adjacent two of the plurality of fingerprint sensing elements is greater than 2 mm.

5. A display device having a display region, comprising:
a fingerprint sensing device, wherein the fingerprint sensing device comprises a substrate, a plurality of fingerprint sensing elements disposed on the substrate in the display region and electrically insulated from each other, and at least one control element disposed on the substrate, wherein each of the plurality of fingerprint sensing elements comprises a plurality of sensors, a plurality of scan lines extending along a direction, a plurality of sensing lines and a plurality of bias lines, a width of one of the plurality of fingerprint sensing elements in the direction ranges from 5 mm to 20 mm, and the plurality of fingerprint sensing elements are controlled independently of each other by the at least one control element,
wherein at least two of the fingerprint sensing elements arranged along the direction are electrically insulated from each other, the at least one control element comprises a driver chip, and the fingerprint sensing device is capable of detecting at least two fingerprints at a same time.

6. The display device as claimed in claim 5, further comprising a display panel, wherein the fingerprint sensing device is disposed on a display surface of the display panel.

7. The display device as claimed in claim 5, further comprising a display panel, wherein the fingerprint sensing device is disposed in the display panel.

8. The display device as claimed in claim 5, wherein the at least one control element comprises at least two control elements, and the at least two of the plurality of fingerprint sensing elements are electrically connected to the at least two control elements respectively.

9. The display device as claimed in claim 5, wherein the at least two of the plurality of fingerprint sensing elements are electrically connected to the at least one control element.

10. The display device as claimed in claim 5, wherein a distance between adjacent two of the plurality of fingerprint sensing elements is greater than 2 mm.
